(19) United States
(12) Patent Application Publication
(10) Pub. No.: US 2023/0186518 A1
(43) Pub. Date: Jun. 15, 2023

(54) SENSOR CALIBRATION WITH RELATIVE OBJECT POSITIONS WITHIN A SCENE

(71) Applicant: GM Cruise Holdings LLC, San Francisco, CA (US)

(72) Inventors: Daniel Chou, Sunnyvale, CA (US); Yongjun Wang, Pleasanton, CA (US); Nigel Rodrigues, San Francisco, CA (US)

(73) Assignee: GM Cruise Holdings LLC, San Francisco, CA (US)

(21) Appl. No.: 17/550,437

(22) Filed: Dec. 14, 2021

(51) Int. Cl. G06T 7/80; G06T 7/70

(52) U.S. Cl. CPC G06T 7/80; G06T 7/70; G06T 2207/10028; G06T 2207/10048

(57) ABSTRACT

To calibrate a set of sensors with respect to one another, such as the respective position and orientation of the sensors, a sensor calibration system uses a well-measured calibration scene in which the objects within the calibration scene have established positions, and optionally orientations (e.g., rotational directions), within the calibration scene and with respect to one another. The calibration scene is captured by a set of sensors to generate respective sensor views of the scene. Each sensor view is analyzed to detect control objects (e.g., features thereof) with respect to the coordinates of each sensor view. Using the known relationship of the calibration objects within the calibration scene, the sensors are calibrated to determine calibration parameters for a joint coordinate system that the maps the detected positions in the sensor view with the relative positions of the measured calibration scene.

### TECHNICAL FIELD

This disclosure relates generally to calibrating a set of sensors, and particularly to calibrating sensor position and orientation with respect to one another for several sensors within a calibration scene.

### BACKGROUND

Various devices may sense an environment around the device and determine movement based on the sensed environment. One example is an autonomous vehicle (AV), which a vehicle that is capable of sensing and navigating its environment with little or no user input and thus be fully autonomous or semi-autonomous. An autonomous vehicle may sense its environment using sensors such as imaging sensors (in visible or infrared light), cameras, time-of-flight sensors, Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, or drive-by-wire systems to navigate the vehicle. Calibration of sensors for an AV or for other environments in which sensors may be attached to a rig, may be difficult to consistently perform and effectively determine intrinsic or extrinsic calibration parameters, particularly for different types of sensors and when the sensors may not each identify the same objects in a calibration scene.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 shows an example calibration scene including example calibration objects and a sensor frame having a set of sensors, according to one embodiment.

FIG. 2 shows an example calibration flow for two sensors with a calibration scene, according to one embodiment.

FIG. 3 shows an example calibration scene for calibrating sensors using calibration objects having a known spatial relationship to one another

FIG. 4 shows an example scene coordinate system having the respective positions of control objects.

FIG. 5 shows an example sensor calibration based on a calibration scene with known positional information between control objects, according to one embodiment.

FIG. 6 shows an example method for calibrating sensors based on a calibration scene with known positional information between control objects, according to one embodiment.

### DETAILED DESCRIPTION

### Overview

For complex systems using a variety of sensors to detect characteristics of an environment, calibration of those sensors is essential to accurately identify objects in the environment, translate sensor-captured information to a joint coordinate system relative to other sensors, and generally acquire an accurate measure of the world around the sensors. For example, systems may include an array of different sensors, such as image sensors (e.g., visible light or infrared cameras), time-of-flight sensors, LIDAR, RADAR, and other types of sensors that capture information about the world. To construct an accurate representation of the environment captured by the sensors, such sensors may need to be calibrated with respect to each respective sensors' relation to one another, such that information captured by those sensors may be effectively merged to a reliable representation of the environment as a whole.

A calibration environment may include various objects to be detected by the sensors and used to calibrate the sensors. The objects are referred to herein as control objects or calibration objects. Various sensors to be calibrated may capture an image of the environment and be calibrated based on detected objects within the environment. Such objects may have distinguishable control points (e.g., specific features or shapes) detectable by algorithms to determine the position of such control objects within a sensor view (e.g., the data captured by the sensor) of the environment. However, such calibration can be difficult across different types of sensors that are capable of reliably recognizing different types of control objects and related control points/features of those objects. For example, imaging sensors may be better able to precisely identify control points on control objects with visual patterns, while a LIDAR or RADAR scan may more precisely identify reflective or planar- shaped control objects.

To improve calibration of different types of sensors, a sensor calibration system uses a well-measured calibration environment in which the calibration objects within a calibration scene have established positions, and optionally orientations (e.g., rotational directions), within the calibration scene. The known locations and/or orientations may be represented with respect to a coordinate system of the calibration scene (a scene coordinate system). The scene may include a variety of calibration objects based on the type of sensors being calibrated. With the known positions of the calibration objects with respect to one another, parameters for sensor calibration may be determined with different types of sensors and even when the sensors do not jointly detect the same control objects.

Each sensor captures a sensor view of the calibration scene including the calibration object. The sensor view is the captured data about the environment by the sensor and may vary depending on the particular sensor (e.g., a camera may capture a two-dimensional image, a LIDAR sensor may capture a point cloud, etc.). Each of the sensors may thus capture a view (a “sensor view”) of the environment from a different position and orientation (e.g., rotation), each of which may be initially unknown with respect to each other and with respect to the calibration scene.

Within each sensor view, a set of control points is detected by a control point detection algorithm to identify the location of one or more control objects within the respective sensor views. The detected control objects are thus detected with respect to the particular field of view or other coordinates particular to the respective sensor and a local coordinate system of the detecting sensor. The detection may also identify a relative rotation of the control object(s) as viewed by the sensor, which may be used to determine the respective angle of view of the sensor with respect to the control object(s). Stated another way, the angle from which the sensor views the control object(s) in the scene may be determined based on a perceived rotation of a control object. In another example, the perceived relationship between several detected control objects may also be used to determine an angle of view of the sensor.

Using the detected control objects in the sensor views, which may include the angle of view to the control object(s), the different sensor views can be calibrated by determining calibration parameters for translating information captured by each respective sensor to a joint coordinate system. Using the known positional relationship between the control objects in the scene, the sensors may be calibrated such that detected positions of the control objects in each sensor view, when translated to the joint coordinate system, match (or optimized to most-closely match) the known positional relationship of the control objects in the scene. This approach may thus enable different types of sensors, which may perceive different control objects, to be calibrated in position and rotation (e.g., 6 degrees of freedom (“6DOF”)) with respect to one another in the joint coordinate system and without requiring a known relationship to the scene or objects from the sensors or a sensor frame on which the sensors are attached.

As will be appreciated by one skilled in the art, aspects of the present disclosure, may be embodied in various manners (e.g., as a method, a system, a computer program product, or a computer-readable storage medium). Accordingly, aspects of the present disclosure may be implemented in hardware, software, or a combination of the two. Thus, processes may be performed with instructions executed on a processor, or various forms of firmware, software, specialized circuity, and so forth. Such processing functions having these various implementations may generally be referred to herein as a “module.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units and in a different order unless such an order is otherwise indicated, inherent or required by the process. Furthermore, aspects of the present disclosure may take the form of one or more computer-readable medium(s), e.g., non-transitory data storage devices or media, having computer-readable program code configured for use by one or more processors or processing elements to perform related processes. Such a computer-readable medium(s) may be included in a computer program product. In various embodiments, such a computer program may, for example, be sent to and received by devices and systems for storage or execution.

This disclosure presents various specific examples. However, various additional configurations will be apparent from the broader principles discussed herein. Accordingly, support for any claims which issue on this application is provided by particular examples as well as such general principles as will be understood by one having ordinary skill in the art.

In the following description, reference is made to the drawings where like reference numerals can indicate identical or functionally similar elements. Elements illustrated in the drawings are not necessarily drawn to scale. Moreover, certain embodiments can include more elements than illustrated in a drawing or a subset of the elements illustrated in a drawing. Further, some embodiments can incorporate any suitable combination of features from two or more drawings.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various examples, these are merely examples used to simplify the present disclosure and are not intended to be limiting.

Reference may be made to the spatial relationships between various components and to the spatial orientation of various aspects of components as depicted in the attached drawings. However, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having,” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

### Sensor Calibration Overview

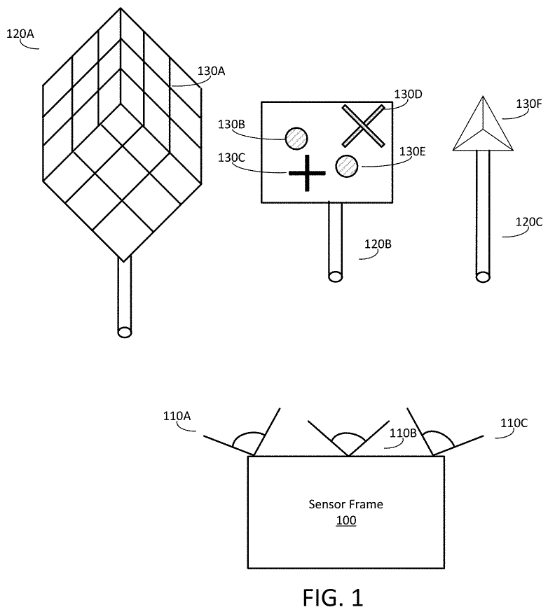

FIG. 1 shows an example calibration scene including example calibration objects 120 and a sensor frame 100 having a set of sensors 110, according to one embodiment. The sensor frame 100 includes one or more sensors 110 for detecting characteristics of the environment around the sensor frame 100. The sensors may be disposed on the sensor frame 100 to capture different views of the environment and may include different types of sensors. In general, the examples discussed herein relate to sensor types such as image sensors, which may capture a two-dimensional image made up of individual pixels, non-visible light sensors (e.g., infrared or ultraviolet imaging), RADAR, LIDAR, and other devices that sense an environment and may be evaluated with respect to detection of portions of objects in an environment.

The sensor frame 100 is a structure on which the sensors 110 are affixed. In general, the sensor frame 100 rigidly fixes the spatial relationship between the sensors 110A-C. The sensor frame 100 may include several such sensors 110, such as the three sensors 110A-110C as shown in FIG. 1. The sensors 110 may be the same type of sensor, for example several different imaging sensors to view different portions of the environment around the sensor frame 100 from various perspectives, or may include different types of sensors, such as a combination of an imaging sensor, a LIDAR sensor, and a RADAR sensor. Various embodiments may include any number and type of sensors 110 according to the particular use of the device. The sensor frame 100 represents the physical structure on which the sensors 110 are disposed, and in various embodiments may have different forms. As one example, the sensor frame 100 may be capable of movement, such as a vehicle, drone, or other system for navigating an environment. The sensors 110 in these configurations may be used (along with related imaging and perception algorithms) to perceive objects and other conditions of the environment and the position of the sensor frame 100 with respect to the environment. In other configurations, the sensor frame 100 may be used to capture aspects of the environment for other purposes, such as generating a three-dimensional representation of the environment (e.g., for generating three-dimensional video content or mapping of an environment). In each of these cases, calibration of the sensors 110 may be essential to correctly perceiving the environment and any further analysis of the captured sensor data. For example, in robotics or automated vehicle use, improperly calibrated sensors may cause the system to misperceive the relative location of objects or environmental features and thus increase the difficulty of successfully navigating the environment.

Such calibration may include intrinsic parameters (e.g., parameters describing calibration of a sensor with respect to its own characteristics), and extrinsic parameters (e.g., parameters describing the position and orientation of a sensors 110 with respect to one another or with the sensor frame 100). Thus, as one example, calibration of intrinsic parameters may determine parameters to correct distortion, warping, or other imperfections of a camera lens. As an example of extrinsic calibration, while the sensors may generally be affixed to the sensor frame 100 according to specific design characteristics (e.g., designating a location for sensor 110A and its orientation in the frame), manufacturing and assembly tolerances may still yield significant variation relative to the sensing capabilities of the sensor 110, such that precisely determining the pose of each sensor 110 relative to one another and the sensor frame 100 improves joint analysis and processing of the individual data from each sensor 110 and successfully generating an accurate model of the environment.

The calibration scene shown in FIG. 1 includes various types of calibration objects 120. In this example, the calibration objects include one or more control points 130 that are identified by analysis of sensor data capture during calibration and used to calibrate the sensors 110. Generally, each control point is a distinguishable feature of the calibration object that is intended to be readily and reliably detected by analysis of the sensor data. As one example, calibration object 120A is an open-faced cube showing three planes, each having a set of straight lines. Analysis of the sensor data capturing the control object 120A may be used to identify a control point 130A (among others on the control object 120A) at the intersections of the lines, or in other cases to identify the individual lines themselves. As one example of calibrating intrinsic parameters, a camera's captured image of the control object 120 may be analyzed to determine a set of parameters for correcting any warping or distortion of the calibration object 120A. Because the lines of calibration object 120A are known to be straight, any bending or curve of the detected control points 130A in the captured image may be corrected with appropriate parameters, such that in the corrected image, the known-straight lines of the control object 120A are straight after application of the intrinsic parameters to the captured image.

Another example calibration object 120B includes several control points 130B-130E. This calibration object 120B may be used to assist in calibrating the position of the multiple sensors with respect to one another. For example, to determine the position and orientation of each sensor with respect to one another based on the detected size, shape, position, orientation, etc., of the detected control points 130B-E on calibration object 120B. As a final example, calibration object 120B includes a trihedral control point 130F. Such a trihedral or “corner reflector” may be used, e.g., for calibration of RADAR sensors and may more readily identified by these sensors. As another example, a calibration object for a LIDAR sensor may include reflective surfaces, such as a set of orthogonal planar surfaces, a sphere, or other identifiable shapes. Thus, the various types of calibration objects 120 and the control points 130 are generally designed to be readily detectable by one or more respective sensors 110 to assist in calibration of the sensor 110.

The control object may take various forms, shapes, sizes, colors, etc., as may the control points to be detected by the control point detection algorithm. As shown in FIG. 1, the control points (e.g., detectable features of the control objects) may include various shapes, such as circles, squares, diamonds, crosses, and in various embodiments may be two or three-dimensional shapes. The control object may also include various control points to be detected in various patterns, such as stripes, crosshatch, or other designs generally designed to be readily detected and distinguished by the control point detection algorithm. The control object may include different colors, such as contrasting colors, to assist in ready detection of the points. The control objects may also vary in shape and size according to the particular sensor being used, for example using image patterns or recognizable shapes for an image sensor, a reflective surface in a suitable shape (e.g., a sphere) for LIDAR, or a trihedral or corner reflector for RADAR detection.

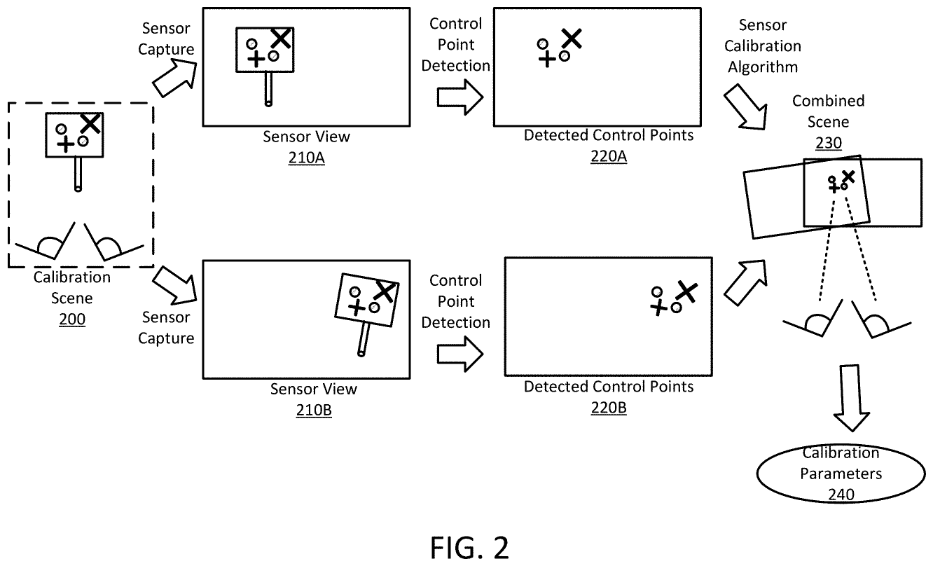

FIG. 2 shows an example calibration flow for two sensors with a calibration scene 200, according to one embodiment. In this example, the calibration scene 200 includes a calibration object similar to the calibration object 120B shown in FIG. 1. In various different configurations, the calibration scene 200 may include many different calibration objects as shown and discussed above. As shown in this example, each sensor captures respective sensor views 210A and 210B. As each sensor captures the control object from different locations, the control object appears in the captured sensor view 210 at different locations and may also appear at different orientations. Using a control point detection algorithm, the sensor view 210 is analyzed to identify one or more detected control points 220A-B in the respective sensor view. Each detected control point may be characterized in various ways in different configurations depending on the control point and the control point detection algorithm. For example, one approach may detect a specific location on a control point (e.g., where the control point is a small circle), while in another approach, the control point detection algorithm identifies an outline of a control point using an edge detection algorithm and may determine an approximate center of the control point based on the detected outline. Though represented in different ways, each detected control point may be represented at a given position in the respective detected control points 220A-B. In the example of an image sensor, the detected control point may be a particular pixel coordinate in the captured image of the calibration scene. In other examples, such as a captured LIDAR point cloud, the location of the detected control point may be a three-dimensional position relative to the origin of the sensor.

The particular control point detection algorithm used may be based on the particular type of sensor as well as the type of control points being detected and the control object on which the control points are disposed. As also discussed above, such control point detection algorithms may include edge detection, object segmentation, detection of round or curved edges, identification of characteristics points, colors, or other signifying characteristics of the control points, and so forth. In addition, various algorithms may be used to analyze or summarize a detected edge or outline of a detected control point to determine a position or location for the control point (e.g., a center of mass or center of area) to represent the position of the control point or the respective control object as a whole. Thus, many different types of detection algorithms may be used, including for the same types of control points and control objects. Certain detection algorithms may be more effective in certain types of scenes, such as well-lit or poorly-lit environments, or areas with significant ambient light, or may more effectively detect different types of control objects.

In this example, the detected control points 220A-B are used to determine extrinsic calibration parameters 240 that describe the position and orientation of the control points such that the detected control points 220A-B from each sensor view 210A-B are aligned in a combined scene 230. Because the detected control points are estimates from the sensor view, the aligned points in the combined scene 230 may be an optimization or estimation of the sensor position and rotation that minimizes the discrepancy between the location at which the same point is identified in each sensor view 210A-B.

### Calibration with Known Control Object Positional Relationships

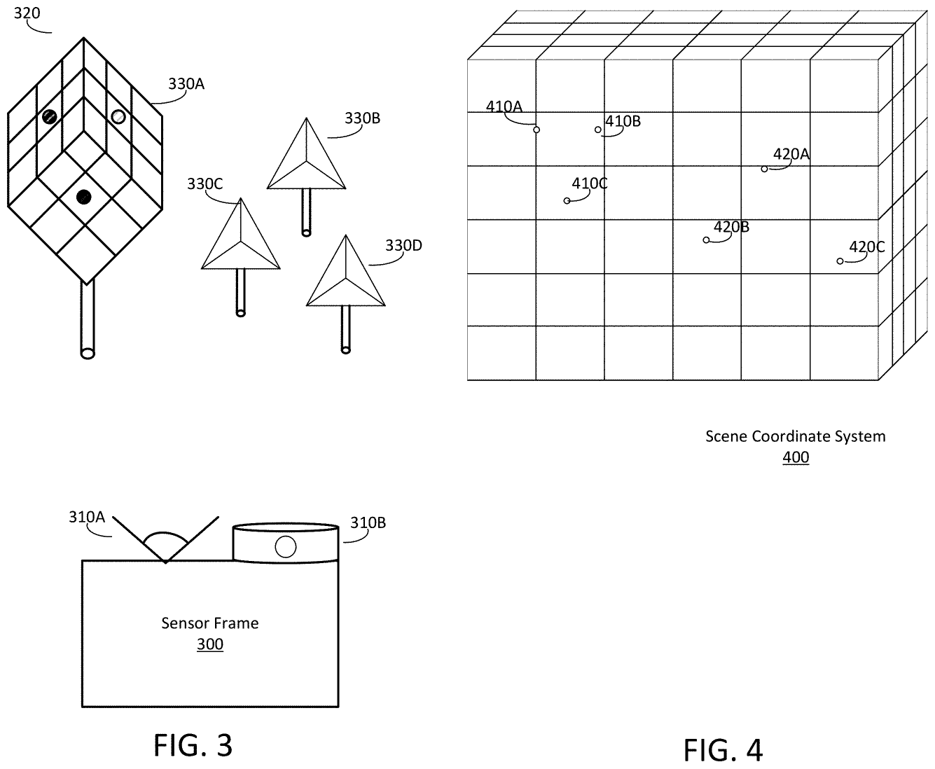

FIG. 3 shows an example calibration scene 320 for calibrating sensors 310A-B using calibration objects 330 having a known positional relationship to one another. In this example, the calibration objects 330 are measured to determine the relative positions of each calibration object 330 (and/or the related control points) with respect to one another and/or with respect to a scene coordinate system. In this example, a sensor frame 300 includes two sensors: an imaging sensor 310A, and a RADAR sensor 310B. Though two sensors 310 are included in this example along with four control objects 330 in the calibration scene 320, in various embodiments different numbers and types of sensors may be included on the sensor frame 300, for example an AV may include a number of cameras in the front, back, and sides of the vehicle, along with one or more RADAR sensors and one or more LIDAR sensors. Each of these sensors may be calibrated together using a calibration scene as discussed herein. Similarly, the calibration scene may include additional calibration objects in a variety of different orientations and positions relative to the sensor frame 300. While the calibration scene 320 in FIG. 3 is shown as including calibration objects 330 in one general direction with respect to the sensor frame 300, in additional embodiments the calibration scene may include calibration objects in many additional directions, distances, and positions with respect to the sensor frame 300. For example, the calibration objects may surround the sensor frame 300 in a panoramic view. The size of the calibration scene 320 and number of objects may be selected based on the number and type of sensors 310 to be calibrated and may for example include at least one calibration object 330 expected to be within the sensor view of each sensor 310 when the calibration is performed (e.g., the sensor frame 300 is positioned for the sensors to capture a sensor view of the calibration scene 320). In addition, the calibration scene may include at least one control object 330 (or set of control objects objects) from which a relative angle of view may be determined for each sensor, such that the relative angle of the sensor towards the calibration scene 320 may be determined.

In the example of FIG. 3, the calibration scene 320 includes a calibration object 330A that includes three planes and respective control points disposed on each plane. The lines and control points may be used to aid determining a point of view of the imaging sensor 310A with respect to the control object 330A. That is, the angle from which the imaging sensor 310A views the control object 330A. The angle of view may be determined based on a perceived rotation of the control object 330 or from a relationship among several control objects 330 having a known relationship among them. For example, while the perceived rotation of control object 330 may be determined based on the relative detected location of the control points and lines on each plane of the control object, each of the control objects 330, when captured by a RADAR sensor 310B may not directly provide information regarding the angle of view of the RADAR sensor 310B. However, because there are three control objects 330B-D, which may be detected by the RADAR sensor 310B with relative relationships between them within the sensor view of the sensor 310B (e.g., the respective position and optionally distance of the control objects 330B-D), the relative angular rotation of the RADAR sensor 310B may be determined. Thus, in general, for each type of sensor, a detected control object or a set of control objects may provide sufficient information for the sensor to estimate its angle of view to the control object(s) in the calibration scene 320.

In this example, the imaging sensor 310A may effectively detect the calibration object 330A and its control points, while the RADAR sensor 310B may effectively detect the control objects 330B-D (here, in the shape of corner reflectors). In other embodiments, different types of control objects may be used based on the particular types of sensors to be calibrated. However, as further discussed below, the particular calibration objects 330 may not need to be detected by more than one sensor or type of sensor to be effective in calibrating the sensors due to the known relationship between the control objects 330.

FIG. 4 shows an example scene coordinate system 400 having the respective positions of control objects. In this example, the scene coordinate system 400 shown in FIG. 4 illustrates the positions of the control objects in the calibration scene 320 of FIG. 3. In this example embodiment, the scene coordinate system 400 is a coordinate system in which the positions of the respective control objects 330 is stored. While in this example the scene coordinate system 400 indicates a distinct coordinate system for the scene as a whole, in other embodiments the relationship between the control objects and respective aspects detectable in the captured sensor views (e.g., individual control points or particular control objects) may be described with respect to the individual relationships of such points. As another example, the scene coordinate system 400 may have an origin point at one of the control objects or detectable control points, from which the location of other control objects or control points is described.

The positions of the control objects 330 may be determined and represented with respect to the particular detection algorithm used in analyzing control points or control objects in the respective sensor views. In this example, analysis of the sensor view from the imaging sensor 310A may individually detect the set of three control points on the planes of the control object 330A. Thus, in the example scene coordinate system 400 of FIG. 4, the control object 330A is represented by a set of control point positions 410A-C, indicating the detectable circular control points on the control object 330A. Likewise, the RADAR sensor 310B may be capable of detecting the general shape and center of mass of the control objects 330B-330D. Accordingly, each control object 330B-D may be represented in the scene coordinate system 400 as control object positions 420A-C. Thus, generally, each control object may be represented in the scene coordinate system 400 by one or more detectable aspects of the respective control object. Similarly, the positions represented in the scene coordinate system 400 may be selected such that the individual positions in the scene coordination system 400 may be matched against individually-detectable control objects (or control points thereof) in the sensor views from the various sensors. In addition, a given control object may include aspects or features that are detectable by different sensors in different ways. Hence, each type of feature or control point for a single control object may have its position represented with respect to other features on the same object or with respect to other features of other objects. As an example, a particular control object may include a corner reflector for RADAR detection, as well as a distinguishable target for image sensor identification. Each of these may be included in the set of respective positions for the control objects in describing the calibration scene. As a result, because the sensor frame may not be a well-calibrated position with respect to the calibration scene, the scene coordinate system 400 may thus be an “arbitrary” frame of reference with respect to the sensor frame and the sensors thereon. However, because the relationship of the objects within the calibration scene are well-defined, this coordinate system may nonetheless be used to calibrate the respective pose (e.g., position and rotation) of the sensors.

Respective positions of the control objects (or distinguishable control points thereof) in the scene coordinate system 400 may be determined by any suitable method. For example, the positions may be determined based on a manual measurement of the calibration scene or may be measured by an already-calibrated set of sensors or a set of high-precision sensors. As another example, the determination of the relative positions may be determined based on a measured relationship of such a high-precision sensor(s) to one or more of the control objects, from which the location of other control objects may be determined from the high-precision sensor. Any other suitable method may be used for determining the “known” positions of the control objects with respect to one another.

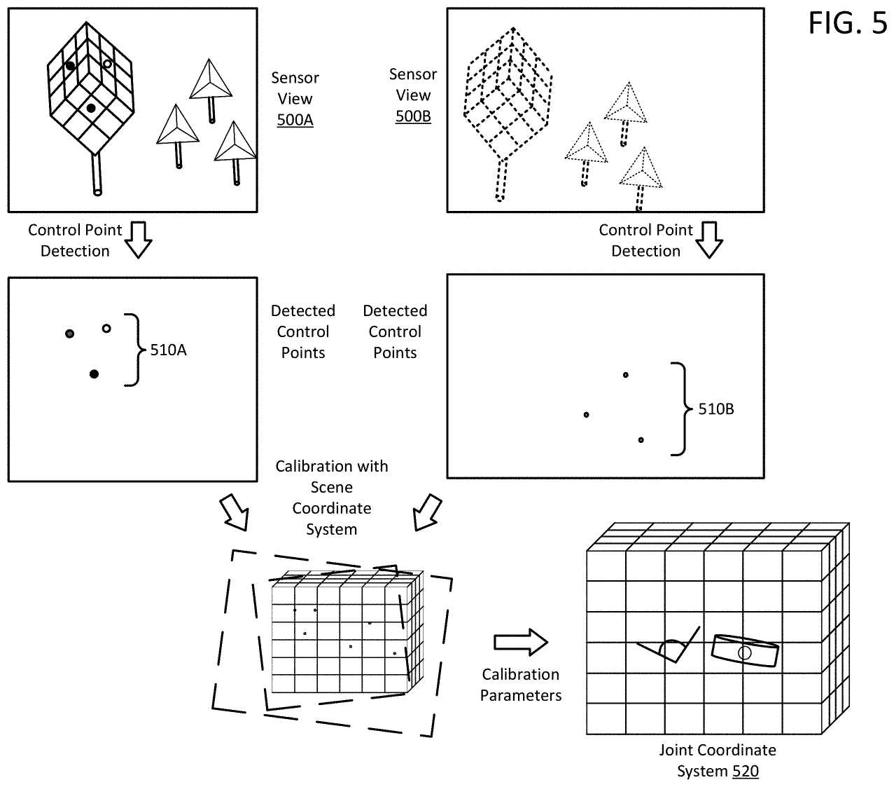

FIG. 5 shows an example sensor calibration based on a calibration scene with known positional information between control objects, according to one embodiment. Continuing the example from FIGS. 3 and 4, each sensor may capture a respective sensor view 500A-B. In this example, sensor view 500A represents an image captured by an imaging sensor (e.g., a camera), and sensor view 500B represents a three-dimensional point cloud detected by a RADAR or LIDAR sensor. As shown by the respective sensor views 500A-B, each sensor may capture the calibration scene with different positions and rotations. From the sensor views 500A-B, a control point (or control object) detection algorithm is applied to determine a set of detected control points 510A-B within the sensor views 500. In this example, the imaging sensor control point detection algorithm identifies a set of control points 510A that are identifiable with the imaging sensor on the control object. Similarly, the control point detection algorithm for the sensor view 500B identifies the set of detected control points 510B. As discussed above, each type of sensor may be analyzed with different control point detection algorithms, which may also be based on the types of control objects and associated features in the calibration scene. For example, the detected control point 510B may be detected to have a position based on a center of the detected control object shapes, such that each control object is represented by one position.

As discussed above, the detected control objects or control points may also analyzed to identify a respective angle of view of the sensor with respect to the detected control object(s). Using the detected control objects in the respective sensor views, the sensor views can now be calibrated based on the known positional relationship in the calibration scene (e.g., as described in a scene coordinate system). The detected control objects/points in each scene may be matched to respective detectable control objects/points of the calibration scene. To perform the calibration, a set of calibration parameters, such as a positional and rotational transform, may be determined for each sensor that when applied to the respective sensor views yields the known positional relationship in the calibration scene. As such, the calibration may attempt to modify the calibration parameters to optimize an error of the position of the detected control objects with respect to the known relationship of the objects in the scene. In addition, the calibration may also account for the perceived angle of view of the sensor with respect to the calibration objects and may determine an angle of view for each sensor (e.g., a rotation) to a particular control object consistent with the detected control objects. In one example, the calibration may be determined with respect to a joint coordinate system. In a further example, the joint coordinate system may have an origin point at one of the sensors, such that the calibration parameters for that sensor is defined as having no transformation.

As shown in FIG. 5, this calibration approach may be successful even when different control objects are detected by different sensors or sensor types because the relationship between such objects is known for the calibration scene. As such, in some embodiments there may be no intersection in the sets of control objects detected by two sensors being calibrated (e.g., there are no control objects in common between them). In addition, this approach may also be used without a pre-defined relationship between the sensors and a sensor frame to which they are affixed, or the sensors and the sensor frame and the control objects in the calibration scene.

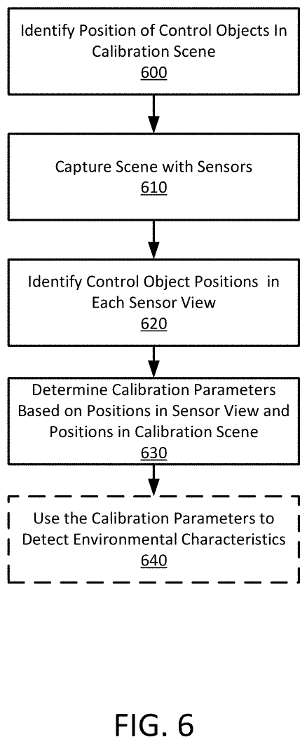

FIG. 6 shows an example method for calibrating sensors based on a calibration scene with known positional information between control objects, according to one embodiment. The method of FIG. 6 may be performed by a sensor calibration system, such as a computing system operating on the sensor frame, or by a computing system in communication with the respective sensors. As an initial step, the calibration scene may be initialized or set up in a physical environment, after which the position of the control objects is identified 600 with respect to one another in the calibration scene. Each of the plurality of sensors on the sensor frame then capture a sensor view of the environment 610, after which the control object positions are identified 620 using detection algorithms as discussed. Using the known relationships and the detected calibration objects in the sensor views, the respective calibration parameters may be determined 630 for a joint coordinate system of the plurality of sensors. Finally, using the calibration parameters, the sensors on the sensor frame may be used to detect environmental characteristics around the sensor frame in additional scenes and environments using the calibration parameters to perceive objects in the environment.

### Select Examples

Example 1 is a method comprising: identifying respective positions of a plurality of control objects in a calibration scene; capturing a plurality of sensor views of the calibration scene, each sensor view being from each of a respective plurality of sensors capturing the calibration scene; identifying positions of a set of detected control objects in each of the plurality of sensor views; and determining calibration parameters for the plurality of sensors with respect to a joint coordinate system that optimizes the respective positions of the sets of detected control objects with respect to the respective positions of the plurality of control objects in the calibration scene.

In Example 2, the method of Example 1 can optionally include, wherein the calibration parameters describe a respective position and rotation of each sensor of the plurality of sensors in the joint coordinate system.

In Example 3, the method of Example 1 or 2 can optionally include, wherein a first set of detected control objects in a first sensor view is different than a second set of detected control objects in a second sensor view.

In Example 4, the method of Example 3 can optionally include, wherein the first set of detected control objects and the second set of detected control objects do not have any control objects in common.

In Example 5, the method of any one of Examples 1-4 can optionally include, wherein the plurality of sensors include two or more of: a visible light imaging sensor, infrared imaging sensor, time-of-flight sensor, a RADAR sensor, and a LIDAR sensor.

In Example 6, the method of any one of the Examples 1-5 can optionally include, determining a rotation of a sensor in the joint coordinate system based at least in part on a detected angle of view of one or more control objects in the set of detected control objects in the sensor view captured by the sensor.

In Example 7, the method of any one of the Examples 1-6 can optionally include wherein an origin point of the joint coordinate system is one of the sensors of the plurality of sensors.

In Example 8, the method of any one of the Examples 1-7 can optionally include wherein the plurality of sensors are affixed to a sensor frame and a distance and angle of the sensor frame to the plurality of objects is not calibrated when the plurality of sensor views is captured.

In Example 9, the method of any one of the Examples 1-8 can optionally include wherein the plurality of sensor views includes a two-dimensional image and a three-dimensional point cloud.

Example 10 is a system comprising: one or more processors; and one or more non-transitory computer-readable storage media containing instructions for execution by the processor for: identifying respective positions of a plurality of control objects in a calibration scene; capturing a plurality of sensor views of the calibration scene, each sensor view being from each of a respective plurality of sensors capturing the calibration scene; identifying positions of a set of detected control objects in each of the plurality of sensor views; and determining calibration parameters for the plurality of sensors with respect to a joint coordinate system that optimizes the respective positions of the sets of detected control objects with respect to the respective positions of the plurality of control objects in the calibration scene.

In Example 11, the system of Example 10 can optionally include wherein the calibration parameters describe a respective position and rotation of each sensor of the plurality of sensors in the joint coordinate system.

In Example 12, the system of Example 10 or 11 can optionally include, wherein a first set of detected control objects in a first sensor view is different than a second set of detected control objects in a second sensor view.

In Example 13, the system of Example 12, wherein the first set of detected control objects and the second set of detected control objects do not have any control objects in common.

In Example 14, the system of any one of Examples 10-13 can optionally include, wherein the plurality of sensors include two or more of: a visible light imaging sensor, infrared imaging sensor, time-of-flight sensor, a RADAR sensor, and a LIDAR sensor.

In Example 15, the system of any one of Examples 10-14 can optionally include the instructions further being for determining a rotation of a sensor in the joint coordinate system based at least in part on a detected angle of view of one or more control objects in the set of detected control objects in the sensor view captured by the sensor.

In Example 16, the system of any one of Examples 10-15 can optionally include wherein an origin point of the joint coordinate system is one of the sensors of the plurality of sensors.

In Example 17, the system of any one of Examples 10-16 can optionally include wherein the plurality of sensors are affixed to a sensor frame and a distance and angle of the sensor frame to the plurality of objects is not calibrated when the plurality of sensor views is captured.

In Example 18, the system of any one of Examples 10-17 can optionally include wherein the plurality of sensor views includes a two-dimensional image and a three-dimensional point cloud.

Example 19 is one or more non-transitory computer-readable storage media containing instructions executable by one or more processors for: identifying respective positions of a plurality of control objects in a calibration scene; capturing a plurality of sensor views of the calibration scene, each sensor view being from each of a respective plurality of sensors capturing the calibration scene; identifying positions of a set of detected control objects in each of the plurality of sensor views; and determining calibration parameters for the plurality of sensors with respect to a joint coordinate system that optimizes the respective positions of the sets of detected control objects with respect to the respective positions of the plurality of control objects in the calibration scene.

In Example 20, Example 19 can optionally include, wherein the calibration parameters describe a respective position and rotation of each sensor of the plurality of sensors in the joint coordinate system.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this disclosure.

Note that in this Specification, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method comprising:
identifying respective positions of a plurality of control objects in a calibration scene;
capturing a plurality of sensor views of the calibration scene, each sensor view being from each of a respective plurality of sensors capturing the calibration scene;
identifying positions of a set of detected control objects in each of the plurality of sensor views; and
determining calibration parameters for the plurality of sensors with respect to a joint coordinate system that optimizes the respective positions of the sets of detected control objects with respect to the respective positions of the plurality of control objects in the calibration scene.

2. The method of claim 1, wherein the calibration parameters describe a respective position and rotation of each sensor of the plurality of sensors in the joint coordinate system.

3. The method of claim 1, wherein a first set of detected control objects in a first sensor view is different than a second set of detected control objects in a second sensor view.

4. The method of claim 3, wherein the first set of detected control objects and the second set of detected control objects do not have any control objects in common.

5. The method of claim 1, wherein the plurality of sensors include two or more of: a visible light imaging sensor, infrared imaging sensor, time-of-flight sensor, a RADAR sensor, and a LIDAR sensor.

6. The method of claim 1, further comprising determining a rotation of a sensor in the joint coordinate system based at least in part on a detected angle of view of one or more control objects in the set of detected control objects in the sensor view captured by the sensor.

7. The method of claim 1, wherein an origin point of the joint coordinate system is one of the sensors of the plurality of sensors.

8. The method of claim 1, wherein the plurality of sensors are affixed to a sensor frame and a distance and angle of the sensor frame to the plurality of objects is not calibrated when the plurality of sensor views is captured.

9. The method of claim 1, wherein the plurality of sensor views includes a two-dimensional image and a three-dimensional point cloud.

10. A system comprising:
one or more processors; and
one or more non-transitory computer-readable storage media containing instructions for execution by the processor for:
identifying respective positions of a plurality of control objects in a calibration scene;
capturing a plurality of sensor views of the calibration scene, each sensor view being from each of a respective plurality of sensors capturing the calibration scene;
identifying positions of a set of detected control objects in each of the plurality of sensor views; and
determining calibration parameters for the plurality of sensors with respect to a joint coordinate system that optimizes the respective positions of the sets of detected control objects with respect to the respective positions of the plurality of control objects in the calibration scene.

11. The system of claim 10, wherein the calibration parameters describe a respective position and rotation of each sensor of the plurality of sensors in the joint coordinate system.

12. The system of claim 10, wherein a first set of detected control objects in a first sensor view is different than a second set of detected control objects in a second sensor view.

13. The system of claim 12, wherein the first set of detected control objects and the second set of detected control objects do not have any control objects in common.

14. The system of claim 10, wherein the plurality of sensors include two or more of: a visible light imaging sensor, infrared imaging sensor, time-of-flight sensor, a RADAR sensor, and a LIDAR sensor.

15. The system of claim 10, the instructions further being for determining a rotation of a sensor in the joint coordinate system based at least in part on a detected angle of view of one or more control objects in the set of detected control objects in the sensor view captured by the sensor.

16. The system of claim 10, wherein an origin point of the joint coordinate system is one of the sensors of the plurality of sensors.

17. The system of claim 10, wherein the plurality of sensors are affixed to a sensor frame and a distance and angle of the sensor frame to the plurality of objects is not calibrated when the plurality of sensor views is captured.

18. The system of claim 10, wherein the plurality of sensor views includes a two-dimensional image and a three-dimensional point cloud.

19. One or more non-transitory computer-readable storage media containing instructions executable by one or more processors for:
identifying respective positions of a plurality of control objects in a calibration scene;
capturing a plurality of sensor views of the calibration scene, each sensor view being from each of a respective plurality of sensors capturing the calibration scene;
identifying positions of a set of detected control objects in each of the plurality of sensor views; and
determining calibration parameters for the plurality of sensors with respect to a joint coordinate system that optimizes the respective positions of the sets of detected control objects with respect to the respective positions of the plurality of control objects in the calibration scene.

20. The one or more non-transitory computer-readable storage media of claim 19, wherein the calibration parameters describe a respective position and rotation of each sensor of the plurality of sensors in the joint coordinate system.
